(19) United States
(12) Patent Application Publication
(10) Pub. No.: US 2026/0099953 A1
(43) Pub. Date: Apr. 9, 2026

(54) MIXING ANALOG AND DIGITAL NEURAL NETWORKS IMPLEMENTATIONS IN VIDEO CODING PROCESSES

(71) Applicant: InterDigital CE Patent Holdings, SAS, Paris (FR)

(72) Inventors: Edouard Francois, Bourg des Comptes (FR); Franck Galpin, Thorigne Fouillard (FR); Thierry Dumas, Rennes (FR); Fabrice Urban, Thorigne Fouillard (FR)

(21) Appl. No.: 19/115,151

(22) PCT Filed: Sep. 14, 2023
(86) PCT No.: PCT/EP2023/075366

§ 371 Date: Mar. 25, 2025

(30) Foreign Application Priority Data
Sep. 26, 2022 (EP) 22306415.5

(51) Int. Cl. G06T 9/00; H04N 19/46

(52) U.S. Cl. CPC G06T 9/002; H04N 19/46

(57) ABSTRACT

A method comprising obtaining (611) video data comprising meta-data representative of a level of reliability of a neural network inference process implemented by an analog device, the neural network inference process being applied to decode the video data, an analog device being an electronic circuitry unable to ensure a repeatability of an output result of said electronic circuitry when said electronic circuitry receives same input data; and, decoding (612) the video data, the implementation of the neural network inference process by the analog device depending on the metadata.

### 1. TECHNICAL FIELD

At least one of the present embodiments generally relates to a method and a device for coding and decoding video data using a neural network inference process and, in particular, a method preventing errors of an execution of the neural network inference process by an analog device as compared to an execution of the neural network inference process by a digital device.

### 2. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

In recently explored video coding solutions, neural network-based processing has been proposed, for example, in a post-filtering stage or for block prediction. One major issue of neural-network (NN) based coding tools is that they require an important number of computations, and lead to important energy consumption in software or hardware implementations. Nevertheless, recent chips developments using analog designs (for example Analog Matrix Processors) allow to significantly reduce the energy usage of NN-based coding tools. However, because of their analog design, these chips may produce non-bit-exact output results. Output is defined in this document as a set of numeric samples, for instance, a 2D picture made of luma samples, a 2D picture made of chroma samples, a 2D picture made of depth samples, a 1D list of motion vector candidates, a 1D list of intra mode candidates, a 2D motion vector fields, each motion vector being made of two samples. As a reminder, a process applying a trained NN to input data to obtain output data is called inference process. This characteristic of analog designs is problematic in video codec wherein output results of coding tools needs to be exact and reproducible. Indeed, it is not admissible in video codecs that two applications of a same NN inference process on same input data provide different output data (which cannot happen with purely digital computations).

It is desirable to propose solutions allowing to overcome the above issues. In particular, it is desirable to propose a solution allowing insuring or at least checking a reliability of an execution of a NN inference process on an analog device.

### 3. BRIEF SUMMARY

In a first aspect, one or more of the present embodiments provide a method comprising: obtaining video data comprising metadata representative of a level of reliability of a neural network inference process implemented by an analog device, the neural network inference process being applied to decode the video data, an analog device being an electronic circuitry unable to ensure a repeatability of an output result of said electronic circuitry when said electronic circuitry receives same input data; decoding the video data, the implementation of the neural network inference process by the analog device depending on the metadata.

In an embodiment, the metadata comprise a flag indicating a presence in the metadata of a first checksum representative of an expected output of the neural network inference process or of a first statistical parameter representative of an expected output of the neural network inference process.

In an embodiment, the metadata comprise a first checksum or a first statistical parameter representative of an expected output of the neural network inference process. In an embodiment, the implementation of the neural network inference process by the analog device comprises executing at least one time the neural network inference process using the analog device and determining that a second checksum or a second statistical parameter computed on an output of one of the at least one execution of the neural network inference process by the analog device is equal respectively to the first checksum or to the first statistical parameter comprised in the metadata, and,
the decoding of the video data comprises decoding the video data using the output of the execution of the neural network inference process by the analog device responsive to the second checksum is equal to the first checksum or responsive to the second statistical parameter is equal to the first statistical parameter.

In an embodiment, the decoding of the video data comprises decoding the video data using an output of an execution of the neural network inference process by a digital device responsive to each second checksum or each second statistical parameter computed on the output of each execution of the neural network inference process by the analog device is different respectively from the first checksum or from the first statistical parameter, a digital device being an electronic circuitry ensuring a repeatability of an output result of said electronic circuitry when said electronic circuitry receives same input data.

In an embodiment, the neural network inference process is executed a plurality of times and responsive to each second checksum or second statistical parameter computed on the output of each execution of the neural network inference process by the analog device is different respectively from the first checksum or the first statistical parameter, the decoding of the video data comprises decoding the video data using an output corresponding to one of:
a median of the outputs of the plurality of executions of the neural network inference process by the analog device;
an arithmetic or a geometric average of the outputs of the plurality of executions of the neural network inference process by the analog device;
an output selected among the outputs of the plurality of executions of the neural network inference process by the analog device such that the second statistical parameter computed from said output is the closest to the first statistical parameter.

In an embodiment, the video data are representative of a scalable video comprising a base layer and at least one enhancement layer and the neural network inference process is comprised in a part of a decoding process related to a decoding of an enhancement layer and, responsive to each second checksum or second statistical parameter computed on the output of each execution of the neural network inference process by the analog device is different respectively from the first checksum or the first statistical parameter, the decoding of the video data comprises decoding the video data by replacing each output of the execution of the neural network inference process by the analog device by an output generated from data computed for the base layer.

In an embodiment, responsive to the flag indicating an absence of the checksum from the metadata or an absence of the statistical parameter from the metadata, the neural network inference process is executed by the analog device.

In an embodiment, the metadata comprise a flag indicating which device using for executing the neural network inference process among an analog device and a digital device, a digital device being an electronic circuitry ensuring a repeatability of an output result of said electronic circuitry when said electronic circuitry receives same input data.

In a second aspect, one or more of the present embodiments provide a method comprising:
encoding video data using an encoding process comprising a neural network inference process, the neural network inference process being executed by a digital device, a digital device being an electronic circuitry ensuring a repeatability of an output result of said electronic circuitry when said electronic circuitry receives same input data;
computing metadata representative of a level of reliability of the neural network inference process implemented by an analog device using an output of the execution of the neural network inference process by the digital device, an analog device being an electronic circuitry unable to ensure a repeatability of an output result of said electronic circuitry when said electronic circuitry receives same input data; and,
signaling the metadata in the encoded video data.

In an embodiment, the metadata are signaled in one of:
a Picture header;
a Slice header;
an Adaptive Parameter Set;
before a first Coding Tree Unit of an area for which the metadata apply;
after a last Coding Tree Unit of an area for which the metadata apply;
in a SEI message attached to the encoded video data;
in a manifest file compliant with a streaming protocol.

In an embodiment, the metadata is computed per group of pictures or per picture or per slice or per tile or per sub-picture.

In an embodiment, the metadata comprise a checksum or a statistical parameter representative of an expected output of the neural network inference process.

In an embodiment, the method further comprises:
analyzing a consistency of an execution of the neural network inference process by an analog device by executing multiple times the neural network inference process using the analog device and comparing outputs of the multiple execution of the neural network inference process by the analog device to the output of the execution of the neural network inference process by the digital device; and,
responsive to a number of outputs of the multiple executions of the neural network inference process by the analog device equal to the output of execution of the neural network inference process by the digital device is below a value, inserting a flag in the metadata indicating that the metadata comprise a checksum or a statistical parameter and otherwise, the flag indicates that the checksum or the statistical parameter is absent from the metadata.

In an embodiment, the flag indicates that the checksum or the statistical parameter is absent from the metadata if all outputs of the multiple executions of the neural network inference process by the analog device are equal to the output of the execution of the neural network inference process by the digital device.

In a third aspect, one or more of the present embodiments provide a device comprising a processor configured for:
obtaining video data comprising metadata representative of a level of reliability of a neural network inference process implemented by an analog device, the neural network inference process being applied to decode the video data, an analog device being an electronic circuitry unable to ensure a repeatability of an output result of said electronic circuitry when said electronic circuitry receives same input data;
decoding the video data, the implementation of the neural network inference process by the analog device depending on the metadata.

In an embodiment, the metadata comprise a flag indicating a presence in the metadata of a first checksum representative of an expected output of the neural network inference process or of a first statistical parameter representative of an expected output of the neural network inference process.

In an embodiment, the metadata comprise a first checksum or a first statistical parameter representative of an expected output of the neural network inference process.

In an embodiment, the implementation of the neural network inference process by the analog device comprises executing at least one time the neural network inference process using the analog device and determining that a second checksum or a second statistical parameter computed on an output of one of the at least one execution of the neural network inference process by the analog device is equal respectively to the first checksum or to the first statistical parameter comprised in the metadata, and,
the decoding of the video data comprises decoding the video data using the output of the execution of the neural network inference process by the analog device responsive to the second checksum is equal to the first checksum or responsive to the second statistical parameter is equal to the first statistical parameter.

In an embodiment, the decoding of the video data comprises decoding the video data using an output of an execution of the neural network inference process by a digital device responsive to each second checksum or each second statistical parameter computed on the output of each execution of the neural network inference process by the analog device is different respectively from the first checksum or from the first statistical parameter, a digital device being an electronic circuitry ensuring a repeatability of an output result of said electronic circuitry when said electronic circuitry receives same input data.

In an embodiment, the processor is configured to execute the neural network inference process a plurality of times and responsive to each second checksum or second statistical parameter computed on the output of each execution of the neural network inference process by the analog device is different respectively from the first checksum or the first statistical parameter, the decoding of the video data comprises decoding the video data using an output corresponding to one of:
a median of the outputs of the plurality of executions of the neural network inference process by the analog device;
an arithmetic or a geometric average of the outputs of the plurality of executions of the neural network inference process by the analog device;
an output selected among the outputs of the plurality of executions of the neural network inference process by the analog device such that the second statistical parameter computed from said output is the closest to the first statistical parameter.

In an embodiment, the video data are representative of a scalable video comprising a base layer and at least one enhancement layer and the neural network inference process is comprised in a part of a decoding process related to a decoding of an enhancement layer and, responsive to each second checksum or second statistical parameter computed on the output of each execution of the neural network inference process by the analog device is different respectively from the first checksum or the first statistical parameter, the decoding of the video data comprises decoding the video data by replacing each output of the execution of the neural network inference process by the analog device by an output generated from data computed for the base layer.

In an embodiment, responsive to the flag indicating an absence of the checksum from the metadata or an absence of the statistical parameter from the metadata, the processor is configure to execute the neural network inference process using the analog device.

In an embodiment, the metadata comprise a flag indicating which device using for executing the neural network inference process among an analog device and a digital device, a digital device being an electronic circuitry ensuring a repeatability of an output result of said electronic circuitry when said electronic circuitry receives same input data.

In a fourth aspect, one or more of the present embodiments provide a device comprising a processor configured for:
encoding video data using an encoding process comprising a neural network inference process, the neural network inference process being executed by a digital device, a digital device being an electronic circuitry ensuring a repeatability of an output result of said electronic circuitry when said electronic circuitry receives same input data;
computing metadata representative of a level of reliability of the neural network inference process implemented by an analog device using an output of the execution of the neural network inference process by the digital device, an analog device being an electronic circuitry unable to ensure a repeatability of an output result of said electronic circuitry when said electronic circuitry receives same input data; and,
signaling the metadata in the encoded video data.

In an embodiment, the metadata are signaled in one of:
a Picture header;
a Slice header;
an Adaptive Parameter Set;
before a first Coding Tree Unit of an area for which the metadata apply;
after a last Coding Tree Unit of an area for which the metadata apply;
in a SEI message attached to the encoded video data;
in a manifest file compliant with a streaming protocol.

In an embodiment, the metadata is computed per group of pictures or per picture or per slice or per tile or per sub-picture.

In an embodiment, the metadata comprise a checksum or a statistical parameter representative of an expected output of the neural network inference process.

In an embodiment, the device is further configured for:
analyzing a consistency of an execution of the neural network inference process by an analog device by executing multiple times the neural network inference process using the analog device and comparing outputs of the multiple execution of the neural network inference process by the analog device to the output of the execution of the neural network inference process by the digital device; and,
responsive to a number of outputs of the multiple executions of the neural network inference process by the analog device equal to the output of execution of the neural network inference process by the digital device is below a value, inserting a flag in the metadata indicating that the metadata comprise a checksum or a statistical parameter and otherwise, the flag indicates that the checksum or the statistical parameter is absent from the metadata.

In an embodiment, the flag indicates that the checksum or the statistical parameter is absent from the metadata if all outputs of the multiple executions of the neural network inference process by the analog device are equal to the output of the execution of the neural network inference process by the digital device.

In a fifth aspect, one or more of the present embodiments provide a signal comprising metadata representative of a level of reliability of the neural network inference process of a video decoding process implemented by an analog device.

In a sixth aspect, one or more of the present embodiments provide a computer program comprising program code instructions for implementing the method according to the first or the second aspect.

In a seventh aspect, one or more of the present embodiments provide a Non-transitory information storage medium storing program code instructions for implementing the method according to the first and the second aspect.

### 4. BRIEF SUMMARY OF THE DRAWINGS

FIG. 1 illustrates schematically a context in which embodiments are implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6A represents schematically an embodiment of a part of a resilient NN inference process implemented by an analog device executed on an encoder side;

FIG. 6B represents schematically an embodiment of a part of a resilient NN inference process implemented by an analog device executed on an decoder side; and,

FIG. 7 illustrates schematically an example of application of a resilient NN inference process implemented by an analog device.

### 5. DETAILED DESCRIPTION

The following examples of embodiments are described in the context of a video format similar to VVC (Recommendation ITU-T H.266|International Standard ISO/IEC 23090-3: Versatile Video Coding) developed by a joint collaborative team of ITU-T and ISO/IEC experts known as the Joint Video Experts Team (JVET)). However, these embodiments are not limited to the video coding/decoding method corresponding to VVC. These embodiments are in particular adapted to various video formats comprising for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), SVC (Scalable Video Coding), SHVC (Scalable High efficiency Video Coding), AV1, AV2 and VP9.

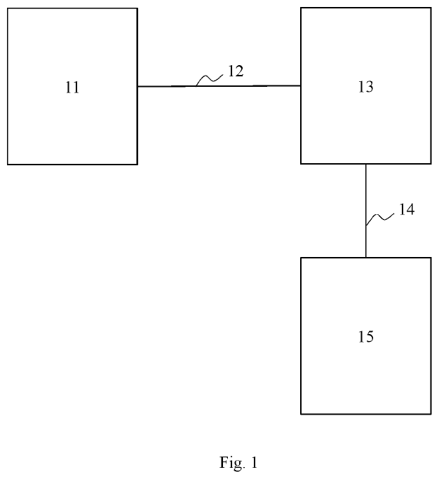

FIG. 1 illustrates schematically a context in which embodiments are implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display system 15 are comprised in a TV, a computer, a tablet, a smartphone, a head-mounted display, etc.

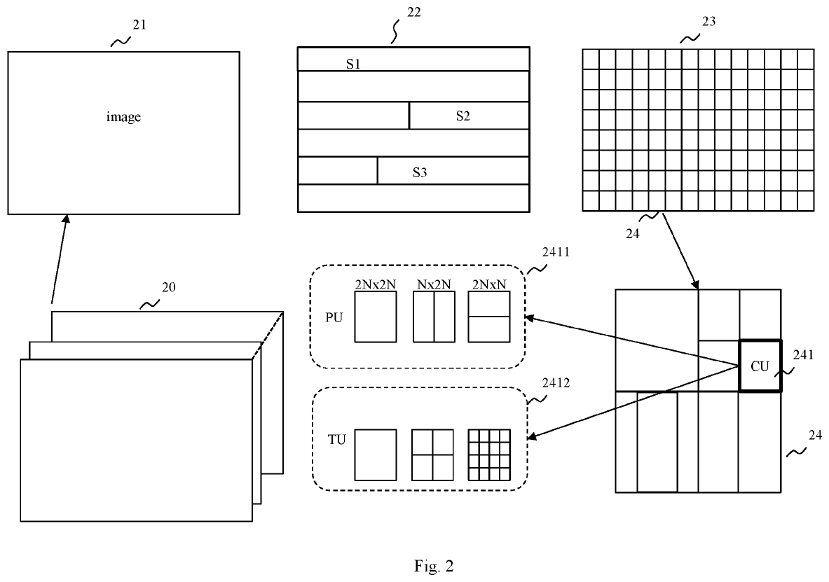

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example of FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 2, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

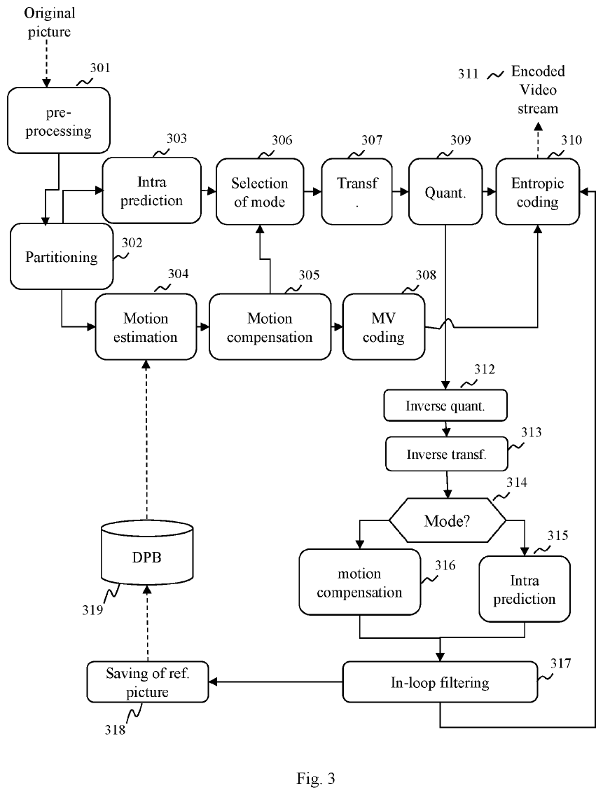

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The inter prediction consists in predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. The transformed block is then quantized during a step 309.

Note that the encoding module can skip the transform and apply quantization directly to the non-transformed residual signal. When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vectors predictors derived from reconstructed blocks situated in a spatial and temporal vicinity of the block to be coded. The motion information is next encoded by the entropic encoder during step 310 in the form of a motion residual and an index for identifying the prediction vector. The transformed and quantized residual block is encoded by the entropic encoder during step 310.

Note that the encoding module can bypass both transform and quantization, i.e., the entropic encoding is applied on the residual without the application of the transform or quantization processes. The result of the entropic encoding is inserted in an encoded video stream 311.

Metadata such as SEI (supplemental enhancement information) messages can be attached to the encoded video stream 311. A SEI message as defined for example in standards such as AVC, HEVC or VVC is a data container associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

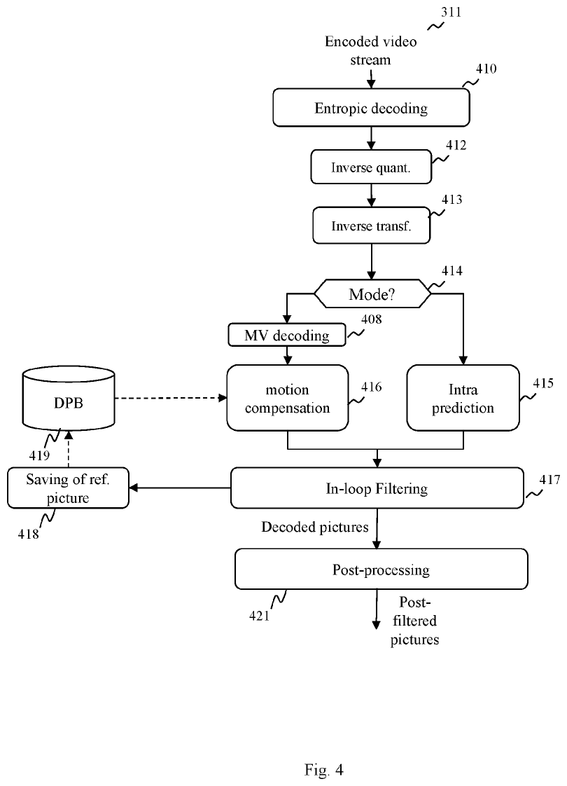

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual. If the block has been encoded according to an intra prediction mode, entropic decoding allows to obtain a prediction direction and a residual block. Steps 412, 413, 414, 415, 416 and 417 implemented by the decoding module are in all respects identical respectively to steps 312, 313, 314, 315, 316 and 317 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given picture. The decoded picture can also be outputted by the decoding module for instance to be displayed.

The post-processing step 421 can comprise an inverse color transform (e.g. conversion from YCbCr 4:2:0 to RGB 4:4:4), an inverse mapping performing the inverse of the remapping process performed in the pre-processing of step 301 and a post-filtering for improving the reconstructed pictures based for example on filter parameters provided in a SEI message.

In recently explored video coding solutions, NN-based tools have been proposed. These NN-based tools or processing can be used at different levels.

In a level “1”, NN-based tools (i.e. NN inference processes) can be used to assist an encoder to make decisions. They can for instance apply for choosing the coding mode of a given CU, choosing the partitioning of a CTU or CU, deciding to apply or not a coding tool (when this tool can be activated/deactivated), choosing a GOP size or structure, choosing a picture type, a slice-or local-QP adaptation. Referring to FIG. 3, this can for instance consist in adding an NN-based decision module prior to steps 302 (partitioning), 307 (e.g. for selecting a transform method), 303 (e.g. for intra coding mode selection), 306 (selection between intra and inter coding, applying or not post-prediction filtering such as Bi-lateral filtering, Bi-direction optical flow filtering), 304, 305 and 308 (inter coding mode selection, decision between uni- or bi-prediction, motion vector prediction, etc).

In a level “2”, NN-based tools (i.e. NN inference processes) can be inserted inside a conventional video decoding framework. They can for instance be used in the intra prediction step (415), in the motion compensation step (416), in the in-loop filtering step (417), in the post-processing step (421). They can also be used in steps involving classifications (for example, coding mode choice at block level, SAO classification, ALF classification, Deblocking filter strength decision), and binary decisions (for example, activation/deactivation of a coding tool, at picture, slice, or block level).

In a level “3”, a complete end-to-end video coding solution is based on a NN design. This can apply to the entire process based on a NN design, or to the main steps (for instance, intra coding using a NN auto-encoder, motion prediction using another NN auto-encoder, residual coding using another NN auto-encoder) of an encoding process.

As already mentioned above, a major issue of NN inference processes are their complexity and the energy consumption they induce. New analog devices that appeared recently, such as analog matrix processors, may provide a solution to these complexity and energy consumption issues. Analog devices basically replace digital multiplication and/or addition steps of digital based implementations by analog processes (not involving digital values but continuous values consisting of voltages). In the various embodiments described in the present document, we define an analog device as an electronic circuitry not ensuring a repeatability of an output result of said electronic circuitry when said electronic circuitry receives same input data, while a digital device is an electronic circuitry ensuring a repeatability of an output result of said electronic circuitry when said electronic circuitry receives same input data. In other words, two applications of a same process to same input data do not necessarily result in the same output data in case of an execution of the process on an analog device, while two applications of a same process to same input data do result in the same output data in case of an execution of the process on a digital device. Indeed, the probability of errors (mismatch of the output compared to a reference output derived from a mathematical fixed-point computation) with a digital device is extremely low and fully negligeable while this probability is high for an analog device. An interest of analog device is their ability to perform NN inference processes with lower power usage than GPUs (for instance 10× lower consumption is claimed in https://www.mythic-ai.com/wp-content/uploads/2021/06/M1076-AMP-Product-Brief-v1.0-1.pdf). In addition, it is known that an analog device would generally provide an erroneous result that is close to a correct result.

However, video codec cannot support approximations in processing results. There is therefore a need for solutions allowing dealing with the main issue of analog based implementations, e.g. the inability of an analog based implementation to insure that a same process applied to same input data would produce a same output result.

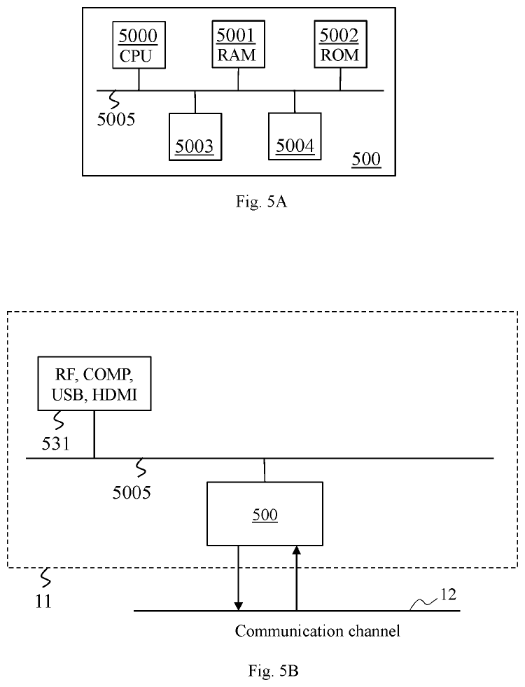

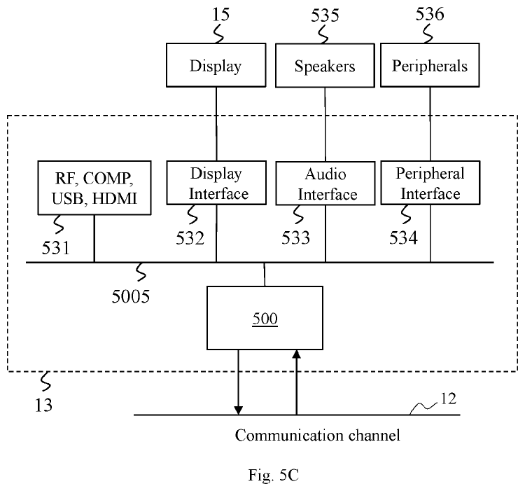

FIGS. 5A, 5B and 5C describes examples of device, apparatus and/or system allowing implementing the various embodiments.

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this system is in charge of encoding the video stream. The decoding module is for example comprised in the system 13.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or system. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

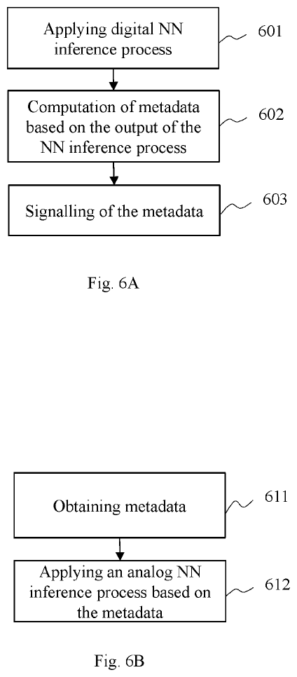

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 and/or an encoding method described in relation to FIG. 3, and methods described in relation to FIG. 6A, 6B or 7, these methods comprising various aspects and embodiments described below in this document.

Some of the algorithms and steps of the methods of FIGS. 3, 4, 6A, 6B and 7 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit). Other algorithms and steps of the methods of FIGS. 3, 4, 6A, 6B and 7 may be implemented by analog devices such as analog matrix processors. In particular, NN inference processes may be implemented by analog devices.

As can be seen, microprocessors, general purpose computers, special purpose computers, processors based or not on a multi-core architecture, DSP, microcontroller, FPGA, ASIC, analog devices such as analog matrix processors are electronic circuitry adapted to implement at least partially the methods of FIGS. 3, 4, 6A, 6B and 7.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communication bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 535, and other peripheral devices 536. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 536 include, in various examples of embodiments, one or more of a stand-alone digital video disc (or digital versatile disc) (DVR, for both terms), a disk player, a stereo system, and/or a lighting system. Various embodiments use one or more peripheral devices 536 that provide a function based on the output of the system 13. For example, a disk player performs the function of playing an output of the system 13.

In various embodiments, control signals are communicated between the system 13 and the display system 15, speakers 535, or other peripheral devices 536 using signaling such as AV. Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 12 in FIG. 5C via the communication interface 5004. The display system 15 and speakers 535 can be integrated in a single unit with the other components of system 13 in an electronic device such as, for example, a television. In various embodiments, the display interface 532 includes a display driver, such as, for example, a timing controller (T Con) chip.

The display system 15 and speaker 535 can alternatively be separate from one or more of the other components. In various embodiments in which the display system 15 and speakers 535 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5C.

Various elements of system 11 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, EVC, SVC, SHVC, etc. In various embodiments, these data are raw data provided for example by a picture and/or audio acquisition module connected to the system 11 or comprised in the system 11. In that case, the processing module 500 take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream (i.e. on encoded video data) in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for checking a reliability of an output of an analog implementation of a NN inference process.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream i.e. to produce encoded video data. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for signaling information allowing checking a reliability of an output of an analog implementation of a NN inference process.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. A digital implementation based on a digital device could also allow reducing the complexity of a rate distortion optimization. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal”can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry an encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

In embodiments described below, modules of a decoding process (for example modules of the decoding process of FIG. 4) are based on NN inference processes executed by an analog device. Solutions are proposed for dealing with errors of the NN inference processes when executed by an analog device as compared to the same NN inference process executed by a digital device. These solutions comprise two aspects:
a signaling process executed on an encoder side consisting in inserting in encoded video data metadata derived from an output of a NN inference process executed by a digital device on the encoder side.
A decoding process consisting in:
   decoding the metadata from the encoded video data;
   applying a resilient NN inference process, based on a NN inference process executed on an analog device and on the decoded metadata, to guarantee that an output of this resilient process produces an expected output.

FIG. 6A represents schematically an embodiment of a part of a resilient NN inference process implemented by an analog device executed on an encoder side.

The process of FIG. 6A is executed for instance by the processing module 500 of the system 11 during the encoding process represented in FIG. 3. For instance, the process of FIG. 6A is executed during the in-loop filtering (step 317), an out-of-loop filtering (executed for instance during the pre-processing step 301), a frame rate up-conversion or frame rate down conversion (executed for instance during the pre-processing step 301), a picture level motion field derivation (executed for instance during the motion estimation step 304 or motion compensation step 305). In the following, we take the example of an in-loop filtering such as SOA of ALF based on a NN inference process (step 317).

In a step 601, the processing module 500 applies a NN inference process implementing an in-loop filtering on a picture. In step 601, the NN inference process is executed by a digital device. In that case, the output of the NN inference process is systematically correct and corresponds to an exact expected result.

In a step 602, the processing module 500 computes metadata representative of a level of reliability of the NN inference process implemented by an analog device. In an embodiment, the metadata representative of a level of reliability of the NN inference process implemented by an analog device is a checksum or statistical parameters computed on the output samples of the execution of the NN inference process implementing the in-loop filtering by the digital device of step 601. Various types of checksums or statistical parameters could be computed in step 602. Checksums comprise error detecting codes. Error detecting codes comprise for instance parity bytes and parity words, cyclic redundancy checks (CRCs), Reed-Solomon codes, MD5sum, etc. Statistical parameters comprise values representative of a signal such as min value, max value, average value, variance, statistical moments of higher order than “2”, histogram (either at full precision (one histogram value per signal codeword, for instance, “1024” histogram values for 10-bit signal), or at reduced precision (one histogram value per signal set of codewords, for instance, 16 histogram values for 10-bit signal, one histogram value concatenating values of intervals of 64 successive codewords, or a bit more with an overlap between each interval)).

In a step 603, the processing module 500 signals the metadata in the encoded video stream (i.e. in the encoded video data). In the case of the in-loop filtering process such as SOA or ALF, since this is a picture-level process, the metadata are associated to a picture corresponding to the picture currently processed. The metadata can be signaled at different levels, such as:
in a Picture header;
in a Slice header;
in an Adaptive Parameter Set (as defined in VVC);
before a first CTU of an area for which the metadata apply;
after a last CTU of an area for which the metadata apply;
in a SEI message attached to the encoded video data;
in a manifest file (Media Presentation Description), in case of streaming protocol such as DASH.

The metadata can also be defined and signaled per area in a global structure such as Picture header, Slice header, Adaptive Parameter Set. For instance, the picture can be split into rectangular areas specified in this global structure, and metadata are signaled for each one of the rectangular areas.

One can note that, in case of loss of a SEI message comprising the metadata, a decoder would consider that the output of the execution of the NN inference process by the analog device is systematically correct.

In the above example of embodiment of FIG. 6A wherein the NN inference process is an in-loop filtering process such as SOA or ALF, since this is a picture-level process, it is natural to compute the metadata (i.e. the checksum) on an entire picture. However, the process can apply at other granularity levels, which means that the checksums can be computed and signaled at different levels: per picture, per slice, per tile, per sub-picture, per rectangular area.

When latency is possible for the application use case (for instance for non-live streaming applications), the metadata computation and signaling can be even made per GOP (Group Of Pictures), i.e. the metadata are computed over all the pictures of the GOP, per intra period (the metadata are computed over all the pictures of the intra period), per group of successive pictures (for instance group of “4” successive pictures in decoding (preferably) or in display order).

In a variant, in step 601, in addition to applying the NN inference process implementing the in-loop filtering on the picture using a digital device to obtain an output output_d, the processing module 500 executes multiple times the NN inference process implementing the in-loop filtering on the picture using an analog device. For instance, the NN inference process is iterated N times using the analog device where N is for example equal to 3. Each iteration provide an output output_a(k) where k∈[0;N−1]. Based on an analysis of a consistency of the output_a(k) with respect to output_d, the encoder can decide to indicate by a flag inserted in the encoded video data whether the metadata is signaled or not. If it is not signaled, a decoding module can confidently apply the NN inference process using an analog device.

In a variant, based on the analysis of the consistency of the output_a(k), the encoder can indicate by a flag inserted in the encoded video data which type of device should be used to implement the NN inference process among an analog device and a digital device. At the decoder side, based on the value of the decoded flag, the decoder applies the NN inference process using either the analog device or the digital device.

The consistency analysis of the outputs output_a(0), . . . , output_a(N−1) can consist in:
checking whether all the output_a(k) are identical to output_d.
or whether a number of outputs output_a(k), k−0 . . . N−1, identical to output_d, is above a threshold (for example “9” iterations over “10” give an output_a(k) equal to output_d).
or whether the maximum error absolute value between the outputs output_a(k) samples and output_d samples, is above a threshold (for example “1”).
or whether the average error absolute value between the outputs output_a(k) samples and output_d samples, is above a threshold (for example “1” for a 10-bit signal, “0.25” for a 8-bit signal).

The criteria listed above are listed independently but several of them can be combined and checked together to derive the flag inserted in the encoded video data indicating which type of device should be used to implement the NN inference process among an analog device and a digital device. For instance, the flag can for instance be set to “1” when the first criterion is true, to indicate that the decoding module can confidently apply the NN inference process using an analog device. And inversely, it is set to “0” when the first criterion is false to indicate that the decoding module must apply the NN inference process using the digital device.

In a variant, the decision is based on the gradient of each sample at the outputs with respect to the inputs. It is known that a NN based system is composed of multiple NN layers, such as convolutional layers. Each NN layer can be described as a function that first multiplies an input by a tensor, add a vector called a bias and then apply a nonlinear function on resulting values. A shape (and other characteristics) of the tensor and a type of non-linear functions are called the architecture of the network. Values of the tensor and the bias are generally by the term weights. The weights and, if applicable, the parameters of the non-linear functions, are called the parameters. The architecture and the parameters define a model. The parameters of the NN model are trained by applying an iterative learning process on large sequences of data. The iterative learning process consists of modifying the parameters of each layer of a NN model, based on gradients of these parameters, related to intermediate inputs of the layer. This process also includes computation of gradients of the output samples related to the input samples. The gradient value of each sample at the outputs with respect to the inputs is representative of a sensitivity of the output values to the intermediate computation. When the gradient amplitudes are low, this means that the outputs are less sensitive than when the gradient amplitudes are high. The flag can be set to “1” to indicate that the decoding module can confidently apply the NN inference process using an analog device when one or all following criteria are true:
the maximum gradient absolute value is above a threshold (for example “0.1”).
the average gradient absolute value is above a threshold (for example “0.01”).

FIG. 6B represents schematically an embodiment of a part of a resilient NN inference process implemented by an analog device executed on a decoder side.

The process of FIG. 6B is executed for instance by the processing module 500 of the system 13 during the decoding process represented in FIG. 4. For instance, the process of FIG. 6B is executed during the in-loop filtering (step 417), an out-of-loop filtering (executed for instance during the post-processing step 421), a frame rate up-conversion (executed for instance during the pre-processing step 421), a picture level motion field derivation (executed for instance during the motion compensation step 305).

In the following, we take the example of an in-loop filtering such as SAO or ALF based on a NN inference process (step 417).

In a step 611, the processing module 500 obtains the encoded video data 311 comprising the metadata representative of a level of reliability of the NN inference process implemented by an analog device computed in step 602 and signaled in step 603.

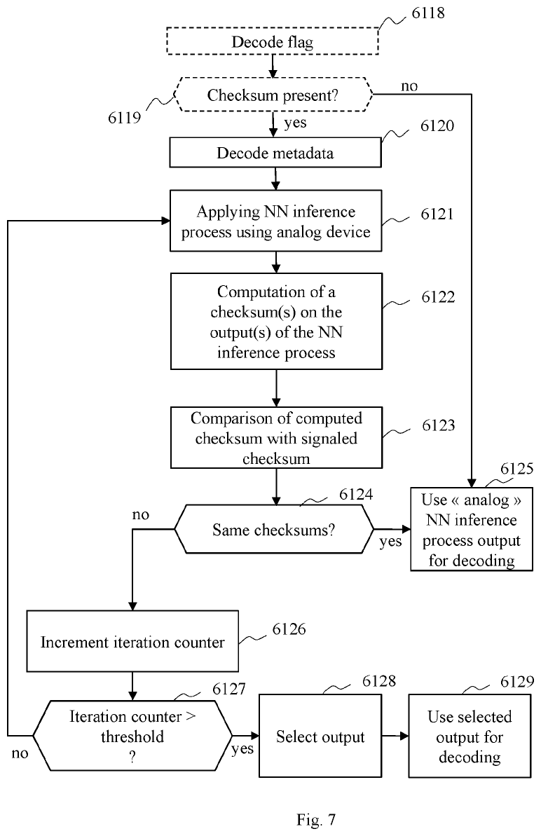

In a step 612, the processing module 500 decodes the video data until step 417. In step 417, the processing module 500 uses the NN inference process implementing the in-loop filtering process to pursue the decoding process. During step 417, the implementation of the NN inference process by an analog device depends on the metadata. Examples of embodiments of step 612 are described below in relation to FIG. 7.

FIG. 7 illustrates schematically an example of application of a resilient NN inference process implemented by an analog device.

The process of FIG. 7 illustrates embodiments of step 612 executed by the processing module 500 of system 13.

In an embodiment, we suppose in FIG. 7 that the metadata comprise a checksum as described in relation to FIG. 6A.

In a step 6120, the processing module 500 decodes the metadata and obtains a checksum. Said checksum was computed on the output of the NN inference process implementing the in-loop filtering process 317 executed by the digital device.

In a step 6121, the processing module 500 applies the NN inference process implementing the in-loop filtering process using an analog device and obtains an output. In the case of the in-loop filtering, the output is for instance an entire picture.

In a step 6122, the processing module 500 computes a checksum on the output of the NN inference process implementing the in-loop filtering process executed by the analog device. The checksum computed in step 6122 is of the same type than the checksum computed in step 602 (i.e. is computed using the same checksum computation algorithm).

In a step 6123, the processing module 500 compares the checksum computed in step 6122 with the signaled checksum decoded in step 6120.

In step 6124, if the two checksums are identical, the processing module 500 continues with a step 6125. Otherwise, the processing module 500 continues with a step 6126.

In step 6125, the processing module 500 uses the output of the NN inference process implementing the in-loop filtering executed by the analog device for decoding. In that case, the picture resulting from the in-loop filtering process is inserted in the DPB 419 in step 418 so that it can be used as a reference picture for temporal prediction.

In step 6126, the processing module 500 increments an iteration counter of one unit.

In a step 6127, the processing module 500 determines if a maximum number of iterations Nmax is attained by the iteration counter. The maximum number of iterations Nmax is for example equal to “10” iterations. Applying several times the in-loop filtering process is not a problem in that case since when executed by an analog device, this process is largely less time consuming and energy consuming than when implemented by a digital device.

If the iteration counter indicates a number of iterations lower than the maximum number of iterations Nmax, the processing module 500 loops back to step 6121.

In a first variant, the maximum number of iterations Nmax is selected such that, in average, in a number of iterations equal to the maximum number of iterations Nmax, at least one iteration allows obtaining a computed checksum equal to the signaled checksum.

In a second variant, if after a number of iterations equal to the maximum number of iterations Nmax, no computed checksum is equal to the signaled checksum, a process is applied to determine a best output from the Nmax outputs of the multiple iterations in a step 6128. For example, the best output is:
a median of the outputs output_a(k) of the Nmax applications of the NN inference process by the analog device, k=0 . . . Nmax−1 (for instance, for each sample position, the sample value is computed as the median value of the samples from output_a(k), k=0 . . . Nmax−1, at the same position);
an arithmetic or a geometric average of the outputs output_a(k) (for instance, for each sample position, the sample value is computed as the arithmetic or a geometric average value of the samples from output_a(k), k=0 . . . Nmax−1, at the same position);
an output selected among the Nmax outputs output_a(k) such that the computed statistical parameter and the signaled statistical parameter are the most similar. This variant applies when the metadata comprise statistical parameters. For example, if the statistical parameter is an histogram, the selected output corresponds to the output output_a(k) having the histogram the closest to the histogram represented by the signaled checksum. Distance between two histograms can be for instance computed using the well-known Kullback-Leibler or Jensen-Shannon divergences.

The best output is then selected for continuing the decoding process. In the case of the NN inference process implementing an in-loop filter, the best output corresponds to a picture that is inserted in the DPB 419 in step 418.

In a third variant, the maximum number of iterations Nmax is equal to at least “1”. In this variant, if each computed checksum is different from the signaled checksum, the output of the NN inference process is discarded in step 6128 and the processing module 500 applies the NN inference process using a digital device in step 6129.

In a variant, the process of FIG. 7 comprises additional step 6118 and 6119.

In step 6118, the processing module 500 decodes from the encoded video data 311 a flag indicating if a checksum is signaled or not in the encoded video data 311.

If no checksum is signaled in the encoded video data, in step 6119, the processing module 500 decides to apply directly step 6125. Otherwise, when the flag indicates that a checksum is signaled in the encoded video data, the processing module applies the process corresponding to steps 6120 to 6129.

In a variant, the step 612 comprises only step 6118 and step 6119. In step 6118, the processing module 500 decodes from the encoded video data 311 a flag indicating which device using to apply the NN inference process among a digital device and an analog device. In step 6119, the processing module 500 decides to use the analog device to implement the NN inference process if it is indicated by the decoded flag and to use the digital device to implement the NN inference process otherwise.

Scalable coding consists in encoding a video at different levels of quality in terms of distortion (SNR scalability), frame rate (temporal scalability) and spatial resolution (spatial scalability). An encoded scalable video comprises generally a plurality of layers comprising a base layer showing the lowest quality, the lowest frame rate and the lowest spatial resolution, and at least one enhancement layer enhancing the quality, frame rate and spatial resolution of the base layer. An enhancement layer depends generally on the base layer, the enhancement in spatial resolution, temporal resolution and distortion being obtained by combining the result of the decoding of the base layer with the result of the decoding of the enhancement(s) layer(s). Many scalable codecs (encoders and decoders) comprise multiple interconnected decoding stages, each decoding stage corresponding to a scalable layer.

In an embodiment adapted to a scalable codec, a NN inference process implemented by an analog device is introduced in at least one decoding stage corresponding to an enhancement layer. In this embodiment, the process of FIG. 7 is applied when decoding each enhancement layer comprising a NN inference process implemented by an analog device.

In a first variant, when no computed checksum is equal to the signaled checksum, instead of
using a digital device to implement the NN inference process;
determining a best output from the Nmax outputs computed using the analog device;
   the processing module 500 replaces the output of the execution of the NN inference process of the enhancement layer by the analog device by an output generated from data computed for the base layer. For instance, when the NN inference process implements an in-loop filter, the output selected in step 6128 is a picture derived from pictures of the base layer, for example, resampled to the spatial resolution of the enhancement layer in case of spatial scalability or interpolated from pictures of the base layer in case of temporal scalability. This picture derived from pictures of the base layer is then inserted in the DPB of the concerned enhancement layer. Otherwise, the output of the NN inference process implementing the in-loop filtering executed by the analog device is used in step 6125.

One can note that in the case of the NN inference process implementing an in-loop filter, the result of the decoding by the enhancement layer before in-loop filtering is generally combined with base layer data to generate an intermediate enhancement layer picture and the in-loop filtering is applied to this intermediate enhancement layer picture to obtain a final enhancement layer picture. The process of FIG. 7 is therefore applied on the result of the combination of decoded base layer data and the intermediate result of the enhancement layer decoding.

In a variant, the process of FIG. 7 is executed before the combination of the base layer data with the partially decoded enhancement layer data. This is the case for instance in case of inter-layer prediction when an enhancement layer and a base layer have a different spatial (respectively temporal) resolution. Inter-layer prediction means that enhancement layer data are at least partially predicted from base layer data. Inter-layer predicted data could comprise samples, motion information, etc. When two layers have different spatial (respectively temporal) resolutions, inter-layer prediction may require an up-sampling (respectively an interpolation) of the base layer data. In the present variant, the up-sampling (respectively the interpolation) of the base layer data is implemented by a NN inference process executed by an analog device. The process of FIG. 7 is used to check the reliability of the up-sampled (respectively interpolated) data outputted by the NN inference process executed by the analog device. If a computed checksum is equal to the signaled checksum (steps 6123, 6124), step 6125 is applied and the outputted up-sampled (respectively interpolated) data are combined with the enhancement layer data. Otherwise, an output of the enhancement layer is generated from the base layer without using the enhancement layer data (step 6129).

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including encoded video data, and performs at least one of the embodiments described.
A TV, set-top box, cell phone, tablet, or other electronic device that receives (e.g. using an antenna) a signal over the air that includes encoded video data, and performs at least one of the embodiments described.
A server, camera, cell phone, tablet or other electronic device that transmits (e.g. using an antenna) a signal over the air that includes encoded video data, and performs at least one of the embodiments described.
A server, camera, cell phone, tablet or other electronic device that tunes (e.g. using a tuner) a channel to transmit a signal including encoded video data, and performs at least one of the embodiments described.

1. A method comprising:
obtaining video data comprising metadata representative of information indicative of a reliability of a neural network inference process implemented by an analog device, the neural network inference process being applied to decode the video data, an analog device being an electronic circuitry unable to ensure a repeatability of an output result of the electronic circuitry when the electronic circuitry receives same input data; and
decoding the video data, the implementation of the neural network inference process depending on the metadata.

2. The method of claim 1, wherein the metadata comprise a flag indicating a presence in the metadata of a first checksum representative of an expected output of the neural network inference process or of a first statistical parameter representative of an expected output of the neural network inference process.

3. The method of claim 1 wherein the metadata comprise a first checksum or a first statistical parameter representative of an expected output of the neural network inference process.

4. The method of claim 3 wherein the implementation of the neural network inference process by the analog device comprises executing at least one time the neural network inference process using the analog device and determining that a second checksum or a second statistical parameter computed on an output of one of the at least one execution of the neural network inference process by the analog device is equal respectively to the first checksum or to the first statistical parameter comprised in the metadata, and
the decoding of the video data comprises decoding the video data using the output of the execution of the neural network inference process by the analog device responsive to the second checksum is equal to the first checksum or responsive to the second statistical parameter is equal to the first statistical parameter.

5. The method of claim 4, wherein the decoding of the video data comprises decoding the video data using an output of an execution of the neural network inference process by a digital device responsive to each second checksum or each second statistical parameter computed on the output of each execution of the neural network inference process by the analog device is different respectively from the first checksum or from the first statistical parameter, a digital device being an electronic circuitry ensuring a repeatability of an output result of the electronic circuitry when the electronic circuitry receives same input data.

6. The method of claim 4, wherein, the neural network inference process is executed a plurality of times and responsive to each second checksum or second statistical parameter computed on the output of each execution of the neural network inference process by the analog device is different respectively from the first checksum or the first statistical parameter, the decoding of the video data comprises decoding the video data using an output corresponding to one of:
a median of the outputs of the plurality of executions of the neural network inference process by the analog device;
an arithmetic or a geometric average of the outputs of the plurality of executions of the neural network inference process by the analog device; or
an output selected among the outputs of the plurality of executions of the neural network inference process by the analog device such that the second statistical parameter computed from the output is the closest to the first statistical parameter.

7. The method of claim 4 wherein the video data are representative of a scalable video comprising a base layer and at least one enhancement layer and the neural network inference process is comprised in a part of a decoding process related to a decoding of an enhancement layer and wherein, responsive to each second checksum or second statistical parameter computed on the output of each execution of the neural network inference process by the analog device is different respectively from the first checksum or the first statistical parameter, the decoding of the video data comprises decoding the video data by replacing each output of the execution of the neural network inference process by the analog device by an output generated from data computed for the base layer.

8. The method of claim 2 wherein, responsive to the flag indicating an absence of the first checksum from the metadata or an absence of the first statistical parameter from the metadata, the neural network inference process is executed by the analog device.

9. The method of claim 1, wherein the metadata comprise a flag indicating which device using for executing the neural network inference process among an analog device and a digital device, a digital device being an electronic circuitry ensuring a repeatability of an output result of the electronic circuitry when the electronic circuitry receives same input data.

10. A method comprising:
encoding video data using an encoding process comprising a neural network inference process, the neural network inference process being executed by a digital device, a digital device being an electronic circuitry ensuring a repeatability of an output result of the electronic circuitry when the electronic circuitry receives same input data;
computing metadata representative of information indicative of a reliability of the neural network inference process implemented by an analog device using an output of the execution of the neural network inference process by the digital device, an analog device being an electronic circuitry unable to ensure a repeatability of an output result of the electronic circuitry when the electronic circuitry receives same input data; and
signaling the metadata in the encoded video data.

11. The method according to claim 10 wherein the metadata are signaled in one of:
a picture header;
a slice header;
an adaptive parameter set;
before a first coding tree unit of an area for which the metadata apply;
after a last coding tree unit of an area for which the metadata apply;
in a supplemental enhancement information (SEI) message attached to the encoded video data; or
in a manifest file compliant with a streaming protocol.

12. The method of claim 10 wherein the metadata is computed per group of pictures or per picture or per slice or per tile or per sub-picture.

13. The method of claim 10 wherein the metadata comprise a checksum or a statistical parameter representative of an expected output of the neural network inference process.

14. The method of claim 10 wherein the method further comprises:
analyzing a consistency of an execution of the neural network inference process by an analog device by executing multiple times the neural network inference process using the analog device and comparing outputs of the multiple execution of the neural network inference process by the analog device to the output of the execution of the neural network inference process by the digital device; and,
responsive to a number of outputs of the multiple executions of the neural network inference process by the analog device equal to the output of execution of the neural network inference process by the digital device is below a value, inserting a flag in the metadata indicating that the metadata comprise a checksum or a statistical parameter and otherwise, the flag indicates that the checksum or the statistical parameter is absent from the metadata.

15. The method of claim 14 wherein the flag indicates that the checksum or the statistical parameter is absent from the metadata if all outputs of the multiple executions of the neural network inference process by the analog device are equal to the output of the execution of the neural network inference process by the digital device.

16. A device comprising a processor configured for:
obtaining video data comprising metadata representative of information indicative of a reliability of a neural network inference process implemented by an analog device, the neural network inference process being applied to decode the video data, an analog device being an electronic circuitry unable to ensure a repeatability of an output result of the electronic circuitry when the electronic circuitry receives same input data; and
decoding the video data, the implementation of the neural network inference process depending on the metadata.

17. The device of claim 16, wherein the metadata comprise a flag indicating a presence in the metadata of a first checksum representative of an expected output of the neural network inference process or of a first statistical parameter representative of an expected output of the neural network inference process.

18. The device of claim 16 wherein the metadata comprise a first checksum or a first statistical parameter representative of an expected output of the neural network inference process.

19. The device of claim 18 wherein the implementation of the neural network inference process by the analog device comprises executing at least one time the neural network inference process using the analog device and determining that a second checksum or a second statistical parameter computed on an output of one of the at least one execution of the neural network inference process by the analog device is equal respectively to the first checksum or to the first statistical parameter comprised in the metadata, and
the decoding of the video data comprises decoding the video data using the output of the execution of the neural network inference process by the analog device responsive to the second checksum is equal to the first checksum or responsive to the second statistical parameter is equal to the first statistical parameter.

20-24. (canceled)

25. A device comprising electronic circuitry configured for:
encoding video data using an encoding process comprising a neural network inference process, the neural network inference process being executed by a digital device, a digital device being an electronic circuitry ensuring a repeatability of an output result of the electronic circuitry when the electronic circuitry receives same input data;
computing metadata representative of information indicative of a reliability of the neural network inference process implemented by an analog device using an output of the execution of the neural network inference process by the digital device, an analog device being an electronic circuitry unable to ensure a repeatability of an output result of the electronic circuitry when the electronic circuitry receives same input data; and
signaling the metadata in the encoded video data.

26-33. (canceled)
